(19) United States
(12) Patent Application Publication
(10) Pub. No.: US 2009/0083395 A1
(43) Pub. Date: Mar. 26, 2009

(54) Proxy Server and Network Computer System

(76) Inventors: Mitsuhiro Shimbo, Yokohama (JP); Masataka Okayama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/211,161

(22) Filed: Sep. 16, 2008

(30) Foreign Application Priority Data
Sep. 20, 2007 (JP) 2007-243551

(51) Int. Cl. G06F 15/16

(52) U.S. Cl. 709/219

(57) ABSTRACT

When, in a network computer system, a Web browser on a host computer acquires information about images or the like from a network or the like, it analyzes the data received in a proxy server, and, in case the details of the data are moving images, transmits substitute images with the same screen size to host computer, and transmits the moving image access information toward user computer. In case substitute images have been transmitted by proxy server, host computer transmits, to user computer, the display position and screen size of the moving images and information indicating Web server saving the moving images. In this way, it is possible, even when a host computer is remotely operated from a user computer via a network and moving images are displayed, to play back the moving images smoothly.

### INCORPORATION BY REFERENCE

This application claims priority from Japanese Patent Application JP 2007-243551, filed on Sep. 20, 2007, the content of which is hereby incorporated by reference into this application.

### BACKGROUND OF THE INVENTION

The present invention pertains to the art of displaying network moving images between computers of a network computer system transmitting and receiving, via a network, information related to remote operation and, in particular, pertains to the art of display information transfers for smoothly playing back moving images.

In network computer systems related to remote operation via a network, the art of carrying out remote operation has been put into practical use by making a connection from an operating-side computer (hereinafter called a “user computer”) to another, operated-side computer (hereinafter called a “host computer”). On the occasion of remote operation, the input operation content carried out by the user computer from a keyboard, a mouse, or the like, is transmitted to the host computer and the information processing corresponding to the same input operation is executed by the host computer. The screen output content due to the host computer is transmitted to the user computer and is displayed on a display device as a remote operation screen.

Generally, since the data volume of screen output content is massive, compression coding is carried out in order to efficiently transmit and receive a remote operation screen with limited network bandwidth. Reference is e.g. made to the pamphlet of International Publication No. 2001/092973.

Further, in order to increase the cipherability in networks utilized by a non-specified majority, such as the Internet, it also occurs that there is used, in combination, encryption of the transmitted and received data and technology pertaining to VPN (Virtual Private Network). In addition, in networks of this kind, there has been the moving image display method, based on cooperation between the host computer and the user computer, making possible stable and smooth moving image display on the user computer of moving images and images delivered by streaming (named generically as “moving pictures”). Reference is e.g. made to JP-A-2007-88960.

### SUMMARY OF THE INVENTION

However, in the technology described in International Publication No. 2001/092973, if an attempt is made to transmit moving images processed for playback in the host computer to the user computer and display them, there is an influence of fluctuations in the transmitted data volume, bandwidth fluctuations on the network, transmission delays, and the like, and there occurs things like the movement of the images stopping and part of the images missing, so there is the problem that smooth images cannot be displayed.

Also, in the art of JP-A-2007-88960 which partially solves this problem, in Web browsers and the like devised to adjust the size of and place, multiple character information and moving image information, as well as information designating the placement of the same information, gets its size adjusted in response to the content thereof, so it is not possible to place the information appropriately.

Accordingly, an object of the present invention resides in furnishing a proxy server and a network computer system that are capable of appropriately placing information and smoothly playing it back, even in the case of making a display based on a Web browser devised to adjust the size of and place multiple pieces of character information and moving image information, as well as information designating the placement of the same information.

The novel characteristics of the aforementioned and other objects of the present invention should become clear from the description and the accompanying drawings in the present specification.

Among the inventions disclosed in the present application, a brief explanation of the outline of a representative one would be as follows.

Specifically, as for the outline of the representative invention, it is one comprising: a proxy server transmitting by proxy to a Web server a request from a host computer, remotely operated from a user computer, to the Web server, acquiring the reply from the Web server, analyzing the details of the same acquired reply, and returning, to the host computer, separate images occupying the same screen size and including information about access to the moving images or the images distributed by streaming, in case the details of the same reply are moving images or images distributed by streaming; and a host computer that, in case the separate images are returned from the proxy server, analyzes the separate images and transmits, to the user computer, the display position and screen size of, and information about access to, the moving images or images distributed by streaming.

Among the inventions disclosed by the present application, the effect obtained by means of the representative invention would briefly described be as mentioned hereinafter.

Specifically, the effect obtained by the representative invention is that, even if the Web browser, or the like, of the host computer does not play back moving images, it is possible to implement smooth moving image playback in the user computer while maintaining the arrangement and also, even regarding the moving images of a Web server in which the transmission and reception procedure is determined, such as a Web server requiring authentication, smooth moving image display becomes possible.

### BRIEF DESCRIPTION OF THE DRAWINGS

FIG. 1 is a block diagram showing the general configuration of a network computer system related to Embodiment 1 of the present invention.

FIG. 2 is a sequence diagram showing the functioning of the content rendering processing of a network computer system related to Embodiment 1 of the present invention.

FIG. 3 is a sequence diagram showing the functioning of the content rendering processing of a network computer system related to Embodiment 1 of the present invention.

FIG. 4 is an explanatory diagram explaining the acquisition of the rendering position and size of the content during functioning of a network computer system related to Embodiment 1 of the present invention.

FIG. 5 is a sequence diagram showing the functioning of the event processing of a network computer system related to Embodiment 1 of the present invention.

FIG. 6 is a sequence diagram showing the functioning of the content rendering processing of a network computer system related to Embodiment 2 of the present invention.

FIG. 7 is a sequence diagram showing the functioning of the content rendering processing of a network computer system related to Embodiment 3 of the present invention.

### DESCRIPTION OF THE EMBODIMENTS

Hereinafter, the embodiments of the present invention will be explained in detail on the basis of the drawings. Further, in all the diagrams for explaining the embodiments, like reference numerals are in principle attached to like parts and repeated explanations thereof will be omitted.

### 1. The First Embodiment

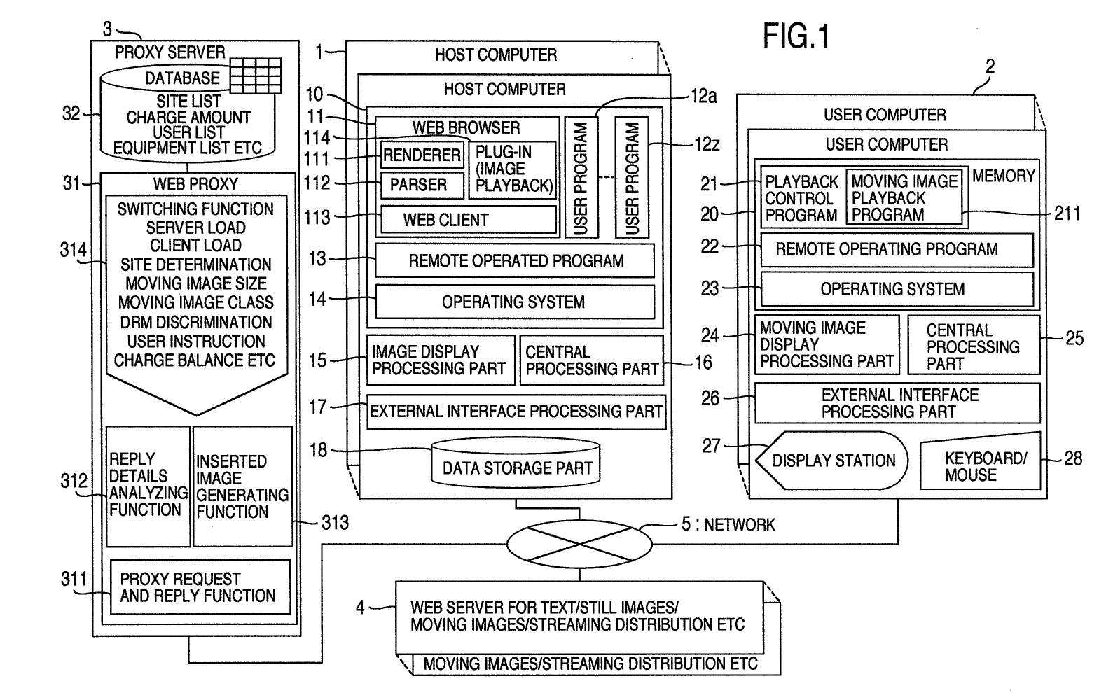

By FIG. 1, there will be given an explanation regarding the overall configuration of a network computer system related to Embodiment 1 of the present invention. FIG. 1 is a block diagram showing the general configuration of a network computer system related to Embodiment 1 of the present invention.

In FIG. 1, the network computer system is configured so as to be able to remotely operate a host computer 1 from a user computer 2 by means of a network 5 and further, there are connected a Web server 4 for text, still images, moving images, streaming distribution, et cetera, and a proxy server 3 carrying out requests by proxy to Web server 4.

In FIG. 1, there are illustrated a plurality of host computers 1, user computers 2, and Web servers 4 and only one proxy server 3 is illustrated, but in the description hereafter, the explanation will be given for one unit each. There may also exist a plurality of proxy servers 3. Also, the functions corresponding to proxy server 3 may be installed within host computer 1. Further, the functions of the Web server may be installed within proxy server 3 or may be installed within host computer 1.

Host computer 1 is provided, in its interior, with a memory 10, an image display processing part 15, a central processing part 16, an external interface processing part 17, and a data storage part 18. These form a mechanism by which information is mutually communicated via an internal connection such as a not illustrated bus or switch. A detailed explanation of the normal functioning as a computer will be omitted here.

In memory 10, a Web browser 11, various user programs 12a to 12z, an operating system 14, and a remote operated program 13 serving as an application program thereof are provided. Web browser 11 comprises a renderer 111 shaping information into a form that can be displayed as an image, a parser 112 analyzing the information, a Web client 113 carrying out communication with the exterior such as Web servers, and a plug-in 114 supporting image playback.

User computer 2 comprises, in its interior, a memory 20, an image display processing part 24, a central processing part 25, an external interface processing part 26, a display station 27 carrying out image display, and a keyboard/mouse 28 receiving input from the user. These form a mechanism, in the same way as for the host computer, by which information is mutually communicated via an internal connection such as a not illustrated bus or switch. In memory 20, there are provided a playback control program 21 including an image playback program 211, an operating system 23, and a remote operating program 22 serving as an application program thereof.

When host computer 1 is remotely operated from user computer 2, remote operating program 22 transmits the input from keyboard/mouse 28 from a user taken to be a human being to remote operated program 13 of host computer 1 via network 5. Remote operated program 13 transmits it to operating system 14 as if there had been an input from the keyboard/mouse connected to host computer 1 and operating system 14 proceeds with the processing in accordance with the input content.

Moreover, the screen output from the host computer is processed by means of the image display processing part, but the rendering information of the processed result is transferred by the remote operated program via network 5 to remote operating program 22 of user computer 2. Remote operating program 22 displays the received image information on display station 27.

Proxy server 3 comprises a database 32 and a Web proxy 31, Web proxy 31 comprising a proxy request and reply function 311, a reply details analyzing function 312, an inserted image generating function 313, and a switching function 314.

Regarding proxy server 3, only the functional blocks are included, and its configuration as a computer may be the same as that of host computer 1 or it may be another one.

Web server 4 is a server carrying out distribution of text, still images, and moving images, streaming distribution, and the like, and its configuration as a computer may be the same as that of host computer 1 or it may be another one.

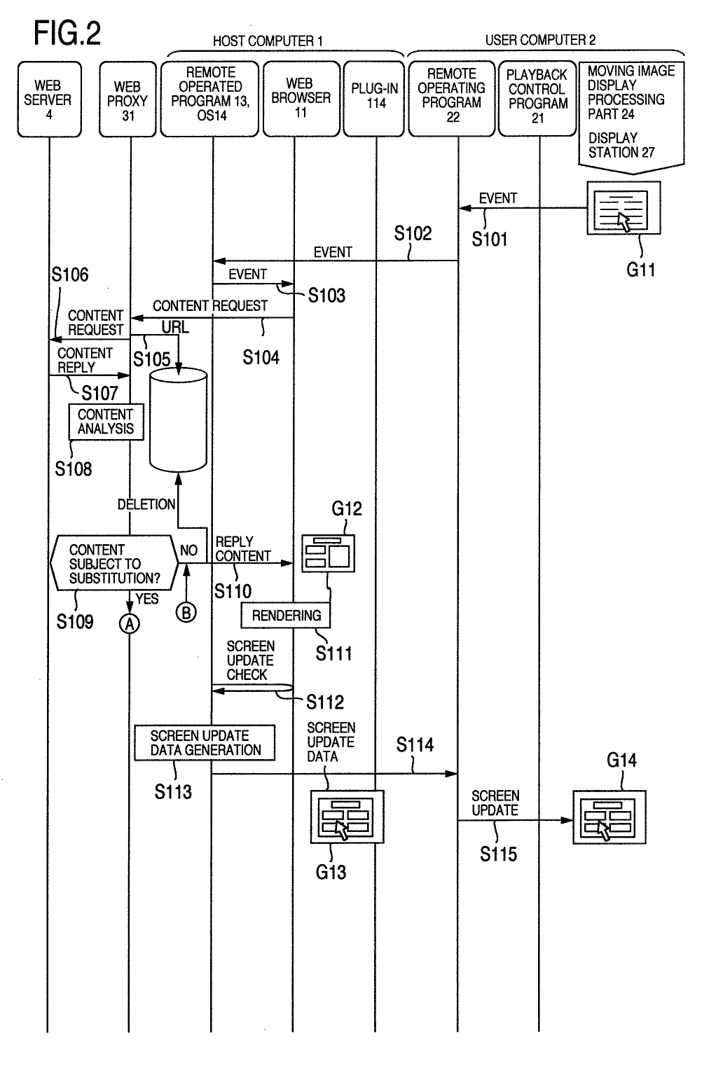

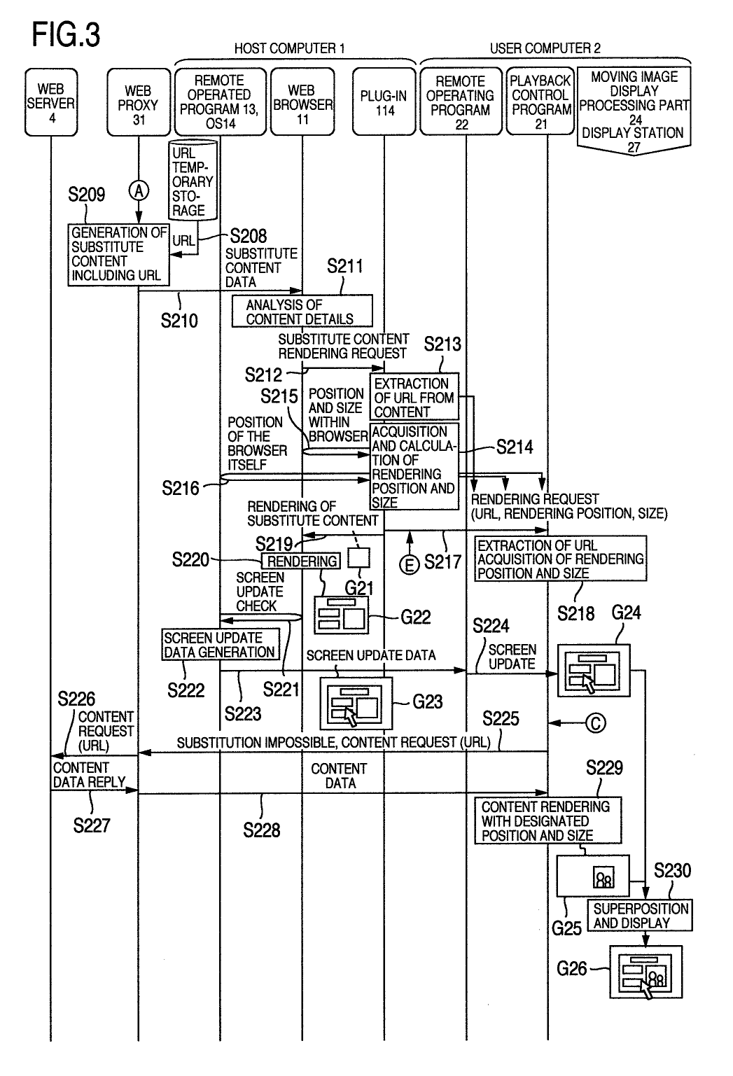

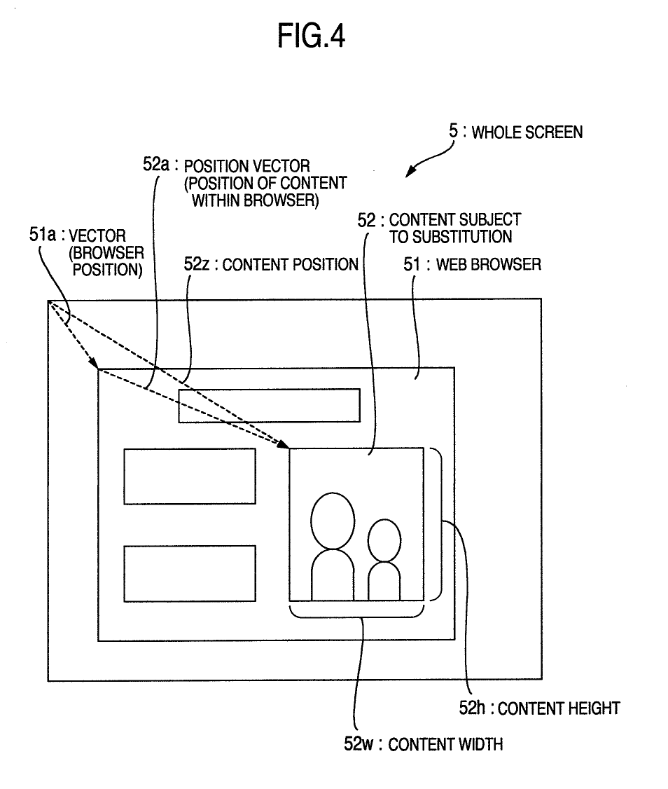

Next, an explanation will be given, by means of FIG. 2 to FIG. 4, of the functioning of the content rendering processing of the network computer system related to Embodiment 1 of the present invention. FIG. 2 and FIG. 3 are sequence diagrams showing the functioning of the content rendering processing of a network computer system related to Embodiment 1 of the present invention and FIG. 4 is an explanatory diagram explaining the acquisition of the rendering position and size of the content during functioning of a network computer system related to Embodiment 1 of the present invention.

FIG. 2 shows a sequence in the case where there is not included a moving image serving as substitute content carrying out substitution processing within a Web page after a page transition, among the page transfer events on Web browser 11 when Web browser 11 is already displayed and FIG. 3 shows a sequence regarding moving image display processing in the case where there is a page transfer on Web browser 11 and a moving image is included within a Web page after a transition, when Web browser 11 is already displayed.

In FIG. 2, in the case where Web browser 11 is already being executed and displayed on display station 27 (G11), if a click is made on a place within Web browser 11 from mouse 28 of user computer 2, the event is reported to remote operating program 22 (Step S101).

Remote operating program 22 reports the event to remote operated program 13 of host computer 1 (Step S102). The remote operated program reports the event to operating system 14 and, since it is an event on Web browser 11, operating system 14 reports the event to Web browser 11 (Step S103).

Since what is concerned, in this case, is a link to Web content within Web browser 11, Web browser 11 emits a content request to Web proxy 31 (Step S104). Web proxy 31, having received this request, temporarily saves the requested URL in a memory inside Web proxy 31 (Step S105), Web proxy 31 transmits by proxy the content request to Web server 4 (Step S106), and Web server 4 transmits the content as a reply (Step S107).

Web proxy 31 having received the content analyzes the received content (Step S108) and judges whether the concerned content is substitute content carrying out substitution processing (Step S109).

In case it is judged that what is concerned in Step S109 is not substitute content, the requested URL saved in the memory inside the Web proxy is deleted and reply content is transmitted to Web browser 11 (Step S110). In case it is judged in Step S109 that what is concerned is substitute content, the process proceeds to the processing of FIG. 3, which will be described subsequently.

The Web browser renders an image (G12) on the basis of the received content (Step S111). Remote operated program 13 verifies the update of the screen via operating system 14 (Step S112), generates the updated portion of the screen update data (Step S113), and transmits the screen update data (G13) to remote operating program 22 (Step S114). Remote operating program 22 updates (G14) the display to display station 27 on the basis of the received data (Step S115).

In FIG. 3, in case it has been judged in Step S109 of FIG. 2 that what is concerned is substitute content, Web proxy 31 acquires a URL being information on access to the content saved in temporary storage (Step S208), generates substitute content embedded in the same URL (Step S209), and transmits it to Web browser 11 (Step S210).

Web browser 11 analyzes the details of the content (Step S211) and transmits the content rendering request to plug-in 114 (Step S212). Plug-in 114 extracts the URL from the received content (Step S213) and, also, determines the rendering position and size of the concerned content (Steps S214, S215, and S216), and transmits these data to playback control program 21 of user computer 2 (Step S217).

Regarding the rendering position and size here, we will now enter into a description of the subsequent steps of plug-in 114, taking the description to be made with the separate FIG. 4. Plug-in 114, after having sent a rendering request to playback control program 21, renders substitute content (G21) and transmits it to the Web browser (Step S219). Web browser 11 makes a rendering (G22) including the content transmitted from the plug-in (Step S220). Steps S221 up to S224 hereafter are the same as Steps S112 to S115 of FIG. 2.

Playback control program 21, having received the rendering request in Step S217, acquires the URL of the rendering request and the position and size thereof (Step S218). It attaches a “substitution impossible” flag to the content of the concerned URL and makes a request to Web proxy 31 (Step S225).

Web proxy 31 emits a content request to the Web server on the basis of the URL (S226), takes receipt of the content data (Step S227), and transmits them to playback control program 21 (Step S228).

Playback control program 21 renders the received content (G25) at the designated position and with the designated size (Step S229) and transfers it to image display processing part 24. Image display processing part 24 superposes the image (G24) received from remote operating program 22 and the image (G25) rendered on the basis of control of playback control program 21 to display (Step S230) an image (G26).

As for the moving image data themselves, since transmission and reception are carried out between playback control program 21 and Web proxy 31, and display control of the moving image is carried out in user computer 2, smooth display becomes possible.

In Step S109 of FIG. 2, there is carried out a judgment as to whether what is concerned is content targeted for substitution, and as for this judgment, various conditions can be used, by means of switching function 314 of FIG. 1 and database 32 used by switching function 314.

E.g., it is possible to carry out playback in user computer 2 in case the size is large due to the size of the moving image and carry out playback in host computer 1 in case the size is small.

Also, it is possible to carry out playback in user computer 2 only in the case of specific types, based on the type of moving images.

Moreover, by holding a list of URLs in database 32, it is possible to carry out playback only of registered URLs in user computer 2.

In addition, regarding content for which DRM (Digital Rights Management) is performed, it is possible to carry out playback in host computer 1.

Also, it is possible to output a playback log and carry out charging on the basis of the present log, for each user or for each user computer, every time that playback is carried out in user computer 2.

In addition, it is possible to have playback with user computer 2 as long as there is a balance of the charge amount for each user (the amount paid in advance by prepayment) and to have playback with host computer 1 in case the charge amount has been used up.

Moreover, it also becomes possible to appropriately put the computer resources to practical use by portioning out the playback places while measuring the processing load of each computer, receiving feedback, and judging where it would be more appropriate to carry out moving image playback processing, with host computer 1 or user computer 2.

Also, the acquisition of the rendering position and size of content, occurring in Steps S214 to S216 of FIG. 3, can, as shown in FIG. 4, be determined by analyzing the details of the content and acquiring information from the Web browser, since e.g. content width 52w and content height 52h are determined by the details of the content and the arrangement on the occasion of rendering by the Web browser.

As for position vector 52z of the content on the whole screen, a position 52a of the content within the Web browser is acquired from the Web browser and in addition, a vector 51a showing the position inside the whole screen of the Web browser is acquired from operating system 14, making it possible to acquire the position as the result of combining the legs thereof.

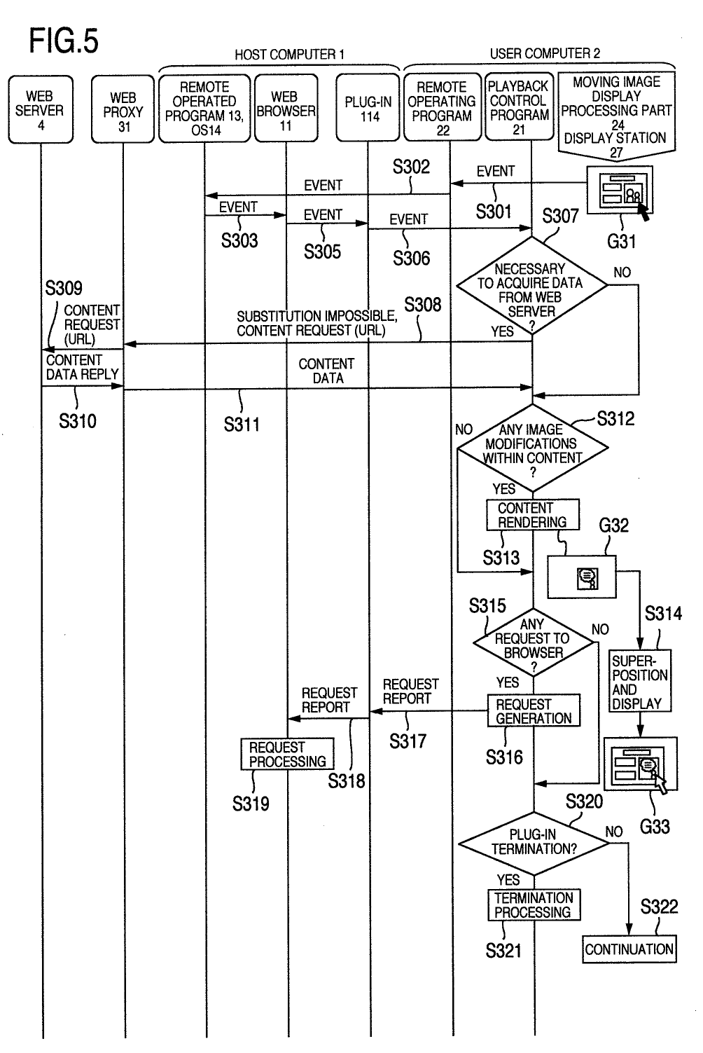

Next, by means of FIG. 5, an explanation will be given regarding the functioning of the event processing of a network computer system related to Embodiment 1 of the present invention. FIG. 5 is a sequence diagram showing the functioning of the event processing of a network computer system related to Embodiment 1 of the present invention and shows the sequence of event processing with respect to images rendered by playback control program 21 of user computer 2.

In display station 27, on the occasion of displaying a screen (G31) including the Web browser, when there has been an event in a moving image, the event is reported like in Steps S301 to S303, similarly to the sequence in FIG. 2. Since the received event is an event in plug-in 114 and there is a need to transfer it to plug-in 114, Web browser 11 transmits it to plug-in 114 (Step S305) and plug-in 114 transmits the event to playback control program 21 (Step S306).

There is a need for playback control program 21 to carry out various processes in accordance with the details of the event, there being shown in FIG. 5 the case of acquiring data from the Web server (Step S307), the case where there is a modification in the details of the content rendering (Step S312), the case where there is a request to the browser (Step S315), and the case where the event has come to an end (Step S320).

In Step S307, in case it is judged that there is a need to acquire data from Web server 4, the data are acquired via Web proxy 31 (Steps S308 to S311), similarly to Steps S225 to S228 of FIG. 3.

In Step S312, in case it is judged that there is a need to modify the details of the rendering, rendering of the content (G32) is carried out (Step S313), it is transferred to image display processing part 24, and processing of a display (G33) to display station 27 is carried out (Step S314).

In Step S315, in case there is a processing request to the Web browser, a request is generated (Step S316), it is reported to plug-in 114 (Step S317), the request is reported from plug-in 114 to Web browser 11 (Step S318), and request processing of Web browser 11 is carried out (Step S319).

In Step S320, in the case of an event of bringing playback control program 21 to an end, playback control program 21 is brought to an end (Step S321), and in the contrary case, operation continues (Step S322).

As mentioned above, in the present embodiment, there are no moving images included in the screen transmitted toward user computer 2 and it is possible to implement smooth moving image display while supporting the arrangement on the screen by having user computer 2 receive a screen in which no moving image is included and simultaneously receive a moving image from a computer indicated by host computer 1 by displaying the moving image superposed on the image received from host computer 1.

### 2. The Second Embodiment

Embodiment 2 is one, in Embodiment 1, that is devised so that it is selected by the user, on the occasion of the playback, whether the moving image playback is carried out by user computer 2 or is carried out by host computer 1.

The configuration of the network computer system of the present embodiment is the same as that of Embodiment 1.

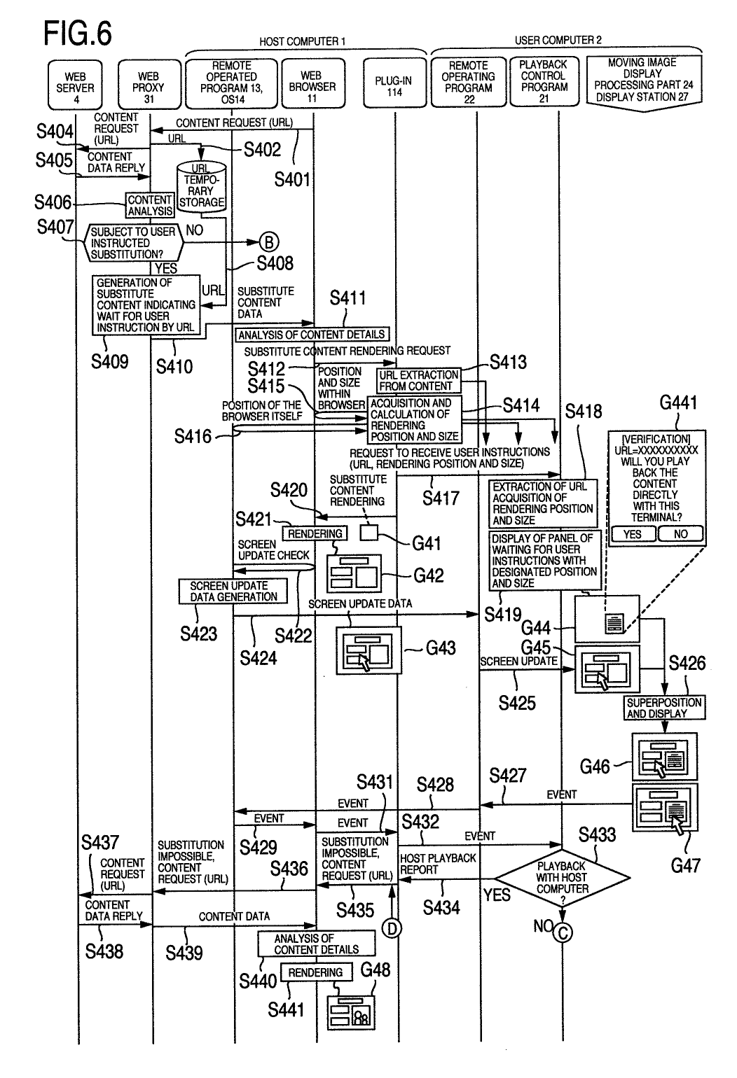

Next, an explanation will be given, by means of FIG. 6, of the functioning of the content rendering processing of a network computer system related to Embodiment 2 of the present invention. FIG. 6 is a sequence diagram showing the functioning of the content rendering processing of a network computer system related to Embodiment 2 of the present invention.

First, similarly to Embodiment 1, in the case where Web browser 11 is already being executed and displayed on display station 27, the same processing as in Steps S101 to S103 of FIG. 2 is carried out if a click from mouse 28 of user computer 2 is made on a place within Web browser 11.

And then, Web browser 11 emits a content request to Web proxy 31 (Step S401). Web proxy 31, having received this request, temporarily saves the requested URL in a memory inside the Web proxy (Step S402), Web proxy 31 transmits by proxy a content request to Web server 4 (Step S404), and Web server 4 transmits the content as a reply (Step S405).

Web proxy 31, having received the content, analyzes the received content (Step S406) and judges whether the concerned content is substitute content for which substitution processing is carried out based on a user instruction (Step S407).

If it is judged that what is concerned is not substitute content for which processing is carried out based on a user instruction in Step S407, processing is carried out from Step S110 onward of FIG. 2.

If it is judged that what is concerned is substitute content for which processing is carried out based on a user instruction in Step S407, the URL constituting information about access to the content temporarily saved in storage is acquired (Step S408), substitute content indicating a wait for user instruction embedded in the same URL is generated (Step S409), and the content data indicating that a user instruction is expected is transmitted to Web browser 11 (Step S410).

Web browser 11 analyzes the details of the content (Step S411) and transmits the content rendering request to plug-in 114 (Step S412). Plug-in 114 extracts the URL from the received content (Step S413) and also, it determines the rendering position and size of the concerned content (Steps S414, S415, and S416) and transmits these data to playback control program 21 of user computer 2 (Step S417).

Playback control program 21 generates a screen requesting verification from the user, generates a screen like e.g. G441, and displays (Step S419) a screen (G44).

Hereinafter, the portions apart from the screen requesting verification (G441) are the same as Steps S219 to S224 in FIG. 3, the program performing rendering by means of a remote operating program in Steps S420 to S425, updating the screen (G45), and superposing it by means of image display processing part 24 and displaying a screen (G46).

Also, if the user launches an event on the displayed verification screen, it is reported to playback control program 21 in the same way as in Steps S301 to S306 of FIG. 5 (Steps S427 to S432).

The playback control program analyzes the event and judges whether the content will be played back by host computer 1 (Step S433). In the case of a user instruction to the effect that the content will be played back with host computer 1, in Step S433, it reports this to plug-in 114 (Step S434).

Plug-in 114 transmits the content request through Web browser 11 and Web proxy 31 to Web server 4 (Steps S435 to S437), the content data being transmitted from Web server 4 to Web browser 11 (Steps S438 and S439).

Web browser 11 analyzes the details of the content (Step S440) and renders (Step S441) a screen (G48). Hereafter, it transmits, in the same way as Step S112 and onward of FIG. 2, the image to user computer 2 by means of remote operated program 13, the image being displayed on display station 27.

In the case of a user instruction to the effect that the content will be played back with user computer 2 without being played back with host computer 1, in Step S433, the program carries out moving image display processing in user computer 2 in the same way as in Step S225 and onward of FIG. 3.

As mentioned above, in the present embodiment, it becomes possible to let the user select whether the content is played back with host computer 1 or is played back with user computer 2, and in the case of playing back with user computer 2, it is possible to implement smooth moving image display while supporting the arrangement on the screen.

### 3. The Third Embodiment

Embodiment 3 is one, in Embodiment 2, that is devised so that a screen requesting verification from the user is generated by plug-in 114.

The configuration of the network computer system of the present embodiment is the same as that of Embodiment 1.

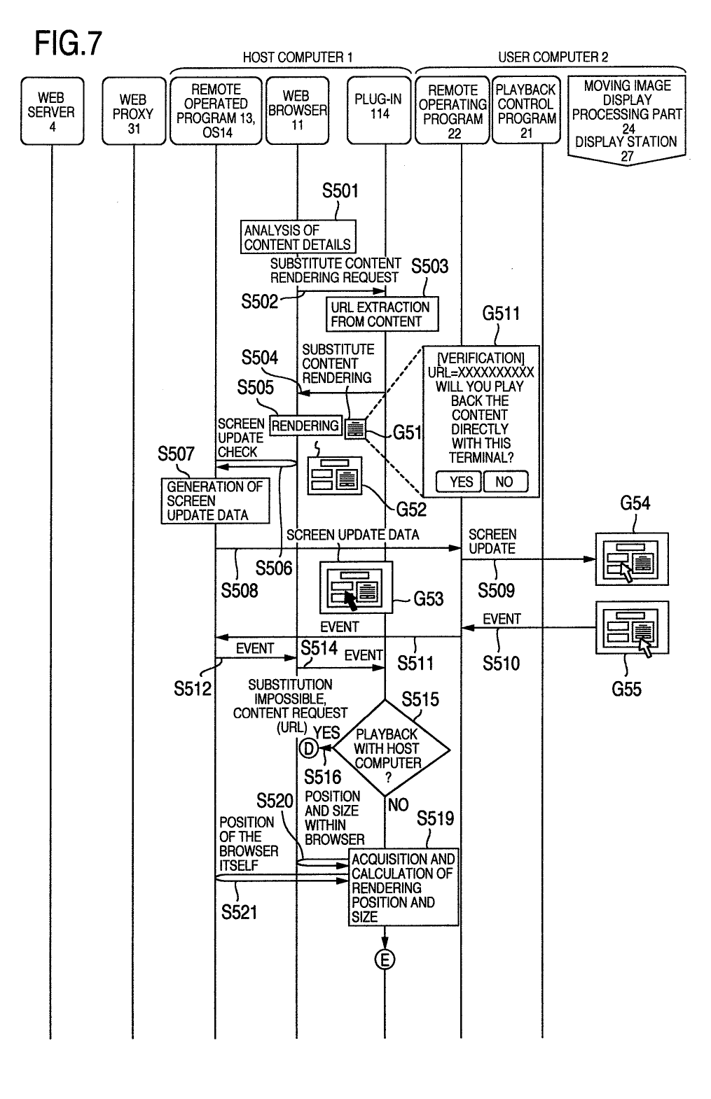

Next, there will be given, by means of FIG. 7, an explanation regarding the functioning of the content rendering processing of a network computer system related to Embodiment 3 of the present invention. FIG. 7 is a sequence diagram showing the functioning of the content rendering processing of a network computer system related to Embodiment 3 of the present invention.

In FIG. 7, as the functioning of a network computer system of the present embodiment, the same processing is carried out as in Embodiment 2, apart from the processing of generating a screen with plug-in 114 requesting verification from the user, and other than the fact that the details carried out by playback control program 21 of FIG. 6 are performed with plug-in 114.

In FIG. 7, Step S501 is a place corresponding to Step S411 in FIG. 6 and the steps from Step S516 onward are the same as the steps from Step S435 onward in FIG. 6. Also, the steps from Steps S519 to S521 onward are the same as Steps S214 to S216 onward of FIG. 3.

As mentioned above, in the present embodiment, the fact of letting the user select whether content is played back with host computer 1 or is played back with user computer 2 becomes possible with treatment by plug-in 114 of host computer 1 and, in the case of playing back with user computer 2, it is possible to implement smooth moving image display while supporting the arrangement on the screen.

In the foregoing, the invention made by the present inventors has been explained in concrete terms on the basis of the embodiments, but the present invention is not one limited to the aforementioned embodiments and it goes without saying that, without departing from the substance thereof, various modifications are possible.

The present invention pertains to the art of displaying network moving images between computers of a network computer system receiving information related to remote operation via the network and is possible to utilize for an information processing system including screen playback based on remote operation. In particular, it is effective in the case of displaying moving images within a Web browser.

It should be further understood by those skilled in the art that although the foregoing description has been made on embodiments of the invention, the invention is not limited thereto and various changes and modifications may be made without departing from the spirit of the invention and the scope of the appended claims.

1. A method for a proxy server connecting an operating-side computer and an operated-side computer via a network and carrying out by proxy requests to a Web server via said network in a network computer system remotely operating said operated-side computer from said operating-side computer, wherein:
a request to said Web server from said operated-side computer remotely operated from said operating-side computer is transmitted by proxy to said Web server;
a reply is acquired from said Web server;
the details of the same acquired reply are analyzed; and,
in the case the details of the same reply are moving images or images distributed by streaming, separate images occupying the same screen size and including information about access to said moving images or said images distributed by streaming are returned to said operated-side computer.

2. The method according to claim 1, wherein the record of said separate images returned to said operated-side computer is saved as a log and is output as information for charging uses with respect to said operated-side computer.

3. A network computer system connecting an operating-side computer and an operated-side computer via a network and remotely operating said operated-side computer from said operating-side computer; comprising:
a proxy server transmitting by proxy to a Web server a request from said operated-side computer remotely operated from said operating-side computer to said Web server, acquiring a reply from said Web server, analyzing the details of the same acquired reply, and in case the details of the same reply are moving images or images distributed by streaming, returning separate images occupying the same screen size and including information about access to said moving images or said images distributed by streaming to said operated-side computer; and wherein:
said operated-side computer, in case said separate images are returned from said proxy server, analyzes said separate images and transmits, to said operating-side computer, the display position and screen size of said moving images or said images distributed by streaming and information about access to said moving images or said images distributed by streaming; and
said operating-side computer, on the basis of information from said operated-side computer, directly accesses and plays back said moving images or said images distributed by streaming, superposes the played back screen on the remote screen from said operated-side computer, and makes a display.

4. The network computer system according to claim 3, wherein:
said operated-side computer carries out a display requesting, from the user of said operating-side computer, a judgment as to whether the playback of said moving images or said images distributed by streaming will be carried out with said operated-side computer or carried out with said operating-side computer.

5. The network computer system according to claim 4, wherein:
said proxy server, on the basis of information about said moving images or said images distributed by streaming, carries out switching between performing the playback, of said moving images or said images distributed by streaming, with said operated-side computer or said operating-side computer.
